(19) United States
(12) Patent Application Publication
(10) Pub. No.: US 2025/0167467 A1
(43) Pub. Date: May 22, 2025

(54) POWER CONNECTION MODULE, WITH CLAMPING OF AN ELECTRIC CABLE TERMINATION BY A STRIP WITH AT LEAST ONE DEFORMABLE PART, INTENDED TO FORM PART OF A TERMINAL BLOCK OF A CONNECTION ASSEMBLY

(71) Applicant: RADIALL, AUBERVILLIERS (FR)

(72) Inventors: Patrice BECAVIN, AUZOUER EN TOURAINE (FR); Flavien ROBERT, MONTLOUIS SUR LOIRE (FR); Stéphane SURAULT, MANTHELAN (FR)

(21) Appl. No.: 18/945,040

(22) Filed: Nov. 12, 2024

(30) Foreign Application Priority Data
Nov. 16, 2023 (FR) 2312553

(51) Int. Cl. H01R 4/48; H01R 9/24

(52) U.S. Cl. CPC H01R 4/483; H01R 9/2416

(57) ABSTRACT

Power connection module, with clamping of an electric cable termination by a strip with at least one deformable part, intended to form part of a terminal block of a connection assembly. An electrical connection module (3, 3′, 3″; 3.1, 3.2, 3.3) intended to form part of a terminal block of a connection assembly, of longitudinal axis (X), having a body provided with a cavity in which, after a cable termination contact has been inserted therein, it is clamped there between a fixed part and a part which is transversely deformable on contact with a strip, the clamping being effected from the outside by a tool and via a clamping mechanism with a cam and a force transmission component, or a lever, accommodated in the body of the module. The cam clamping mechanism provides the individual clamping of a termination contact in order to ensure the desired electrical continuity with a considerable force and a reduced space requirement within the module, the body of which has small dimensions.

### TECHNICAL FIELD

The present invention relates to the field of electric power connectors.

More particularly, it relates to terminal block connection assemblies.

Here and within the context of the present invention, a “terminal block” is understood to be a device for ensuring electrical continuity between a cable and another part of an installation. A terminal block, also known as connection terminal or screw terminal, is an electrically insulated module which fixes together two or more electric wires/cables intended to be electrically interconnected, and comprises an insulating support and at least one clamping component for fixing the wires/cables.

Here and within the context of the present invention, a “contact” is understood to be an element made of electrically conductive material for transmitting electrical current.

Although it is described with reference to a preferred application, that of aeronautics, and more particularly the wiring of aircraft, the invention may be implemented in any other application that requires a power connection, in particular several hundred amps and/or volts and particularly a lot of electric cables/wires among one another in a junction area.

### BACKGROUND

One of the operations in the wiring of aircraft consists in electrically interconnecting a lot of electric power cables/wires.

This operation is usually implemented using a screw terminal block which is fixed to the structure of the aircraft and in which the plurality of electric cables/wires is inserted and then fixed by clamping.

FIGS. 1 and 2 show an example of such an existing terminal block, denoted overall by the reference 1, which is designed to connect two or more electric cables 2 fitted with lugs 20 at their ends by a screw/nut system.

This terminal block 1 firstly comprises an electrically insulating support 10 in which there are fixed terminal screws 11 that each form, with a nut 12, a screw/nut system for clamping the lugs 20 fitted to the cables 2.

An in particular electrically conductive washer 13, of the crinkle washer type, is provided for each screw/nut system.

Each terminal screw 11 passes through an electrically conductive bar 14. This bar 14 forms a bearing surface for the cable lugs 20 and thus forms an electric shunt between the cables 2 to be electrically connected. This plate 14 is optional and each screw 11 is electrically independent. As an alternative, the plate 14 may extend only over a partial length and electrically connect only some of the screws.

The support 10 is fixed to an aircraft structure S by column screws 15.

A cover 16 held by the column screws 15 forms a protective cover for the systems of screws and nuts 11, 12.

Since the terminal block 1 is not leaktight, an additional cover, commonly called an “umbrella”, is fixed to the structure of the aircraft, above the terminal block, to prevent condensed moisture from running off directly onto the cables 2 connected in the terminal block.

In addition to this non-leaktight aspect, such a screw terminal block 1 has numerous major drawbacks.

First of all, the lugs 20 have to be oriented perfectly in order to be threaded around the terminal screws 11 for a satisfactory electrical connection. More often than not, this means that an operator has to untwist the cables 2.

The number of components to be managed (screws, nuts, washers, shunt bar, cover, umbrella component) by an operator responsible for assembly is high and, in addition, there is a high risk of losing components, which therefore leads to the risk that a foreign object or mechanical debris can cause damage (FOD, which stands for “Foreign Object Damage”), the intention being definitively to avoid this in the field of aeronautics.

This risk of losing components is all the greater if the areas in which the existing terminal blocks 1 are fitted are difficult to access and/or have very restricted access and/or are in an awkward location for the operator. For example, the insulating support 10 is usually fixed on the ceiling in the structure of an aircraft. This can mean that the lugs installed on the screws 11 do not stay in place before also having fitted a nut 12. In other words, there is no function of preliminary holding in position of the lugs on the screws.

In addition to the intrinsic clamping operations by means of screws, which can take a long time for a dedicated operator, another operator is dedicated to systematically checking the clamping torques applied to fix the lugs 20 of the cables.

It is also the case that a screw terminal block requires the cables not to be powered on in order to avoid electrical risks for the operators responsible for the electrical connection. Moreover, these risks cannot be completely eliminated during tests for checking correct operation.

As a result, ultimately, it takes a long time to install a screw terminal block.

In addition, the lugs 20 can require a 180° orientation, this not being very compatible with power cables which are rigid, typically with a diameter of about AWG 000 (measurement unit “American Wire Gauge”), i.e. 10.4 mm.

Lastly, screw terminal blocks do not allow modularity, because the number of cables 2 that can be connected in just one and the same terminal block is fixed.

Patent U.S. Pat. No. 10,998,649B2 discloses a terminal block in which, after it has been inserted into a cavity of a body, an electric cable conductor is clamped between a fixed strip and a movable and deformable strip actuated by an operator directly using a rotary lever. This solution cannot be adapted directly to a cable termination. In addition, the clamping force is reduced. Lastly, the inserted conductor is not locked in place. The space needed for actuation of the rotary lever is also significant, requiring good accessibility for the operator's hand. However, such access is far from possible in an aeronautical environment. Detection of the correct insertion of the cable is also not performed.

CN211404771U also discloses a terminal block in which a cable conductor is clamped by deformation of a contact strip by means of a set screw. This solution has the same drawbacks as that of patent U.S. Pat. No. 10,998,649B2. Moreover, the ending of the clamping force cannot be determined because it is directly linked to the manual screwing performed. Detection of the correct insertion, at the correct depth, of the conductor is not performed.

To improve the existing terminal blocks, the applicant's patent application EP3758165 proposed a connection assembly which makes it possible to add greater modularity, makes the installation easier, more particularly in areas with restricted access and/or for a lot of electric wires/cables to be connected, and makes it possible to protect the operators responsible for the connection against electrical risks.

Although this solution is completely satisfactory, there is still a need for improvement, in particular for transmitting high currents, typically up to 400 A, which involves a high contact pressure and therefore a high connection force, without premature wear of the contacts arising.

The invention aims to meet this need fully or in part.

### SUMMARY

To this end, the invention relates, according to one of its aspects, to an electrical connection module, intended to form part of a terminal block of a connection assembly, of longitudinal axis (X), comprising:
at least one body made of electrically insulating material comprising at least one cavity, extending along the axis X and designed to accommodate an electric cable termination, comprising a preferably cylindrical contact intended to be attached to, preferably crimped onto, an electric cable;
at least one strip, comprising at least one part of a strip which is electrically conductive and accommodated, fixedly or with play, at least partially in the cavity, and at least one part of a strip which is elastically deformable between a rest position, in which it defines a space designed to enable the insertion of the contact of the electric cable termination along the axis X, and a deformed position in which it clamps the contact of the electric cable termination transversely to the axis X so as to establish electrical continuity between the contact and the one or more strips;
at least one clamping mechanism intended to be actuated by rotation from the outside, comprising a means for converting a rotational movement into a translational movement transversely to the axis X, which exerts a force (F) on the deformable part of the strip to bring it from its rest position to its deformed position of clamping the contact of the electric cable termination.

In other words, the invention consists essentially of a module for a terminal block connection assembly having a body provided with a cavity in which, after a cable termination contact has been inserted therein, it is clamped there between a fixed part and a part which is transversely deformable on contact with a strip, the clamping being effected from the outside by a tool and via a clamping mechanism with a cam and a force transmission component, or a lever, accommodated in the body of the module.

The cam clamping mechanism provides the individual clamping of a termination contact in order to ensure the desired electrical continuity with a considerable force and a reduced space requirement within the module, the body of which has small dimensions.

Advantageously, the force transmission component is configured to be able to be inserted into a transverse recess of the termination contact in order to indicate the correct positioning (insertion) of the contact in the cavity. If the insertion is not correct, the force transmission component comes into abutment against a part of the preferably cylindrical contact, which does not allow the clamping mechanism to be actuated. Furthermore, the force transmission component prevents any sliding of the contact between the metal plates.

In an advantageous option, a locking device makes it possible to lock the mechanism in the deformed position of the strip and therefore in the configuration in which the contact is clamped for the desired electrical continuity.

The one or more strips are shaped so as to form at least two, advantageously three areas of direct linear or surface contact with the contact of the electric termination in the deformed position of the second strip.

These areas of linear or surface contact are, preferably regularly, angularly distributed around the periphery of the contact. Advantageously, three areas of linear contact are arranged substantially at 120° relative to one another.

With these contact areas distributed angularly around the contact, clamping that is well distributed around a cylindrical electric-termination contact is thus ensured.

According to an advantageous embodiment of the invention, the module comprises a single strip with a substantially U-shaped cross section transversely to the axis X.

According to this embodiment, the clamping mechanism advantageously comprises a lever mounted pivotably in the body and accessible from the outside so as to deform at least one of the two arms of the U and thus bring it from its rest position to its deformed position.

According to another advantageous embodiment of the invention, the module comprises at least one electrically conductive, rigid first strip accommodated in the cavity, and at least one electrically conductive second strip accommodated in the cavity and comprising at least one part which is elastically deformable between the rest position and the deformed position.

According to this other embodiment, the clamping mechanism comprises:
a force transmission component accommodated in the body,
an interface component for a tool (H), this interface component being freely rotatably mounted in a receiving portion of the body and designed to be made to rotate by the tool,
a clamping cam secured to or integrally formed with the interface component, the rotation of the clamping cam causing the force transmission component to move in translation transversely to the axis X, which exerts a force (F) on the second strip to bring it from its rest position to its deformed position of clamping the contact of the electric cable termination.

Advantageously, the interface component may comprise an interface recess for the tool, preferably a hexagonal socket recess.

According to an advantageous embodiment variant, the body of the module and/or the interface component comprise(s) at least one visual indicator arranged so as to be visible to an operator to indicate to them that the clamping position of the contact of the electric termination is correct. The body of the module and/or the interface component may thus comprise a noticeable colored area as visual indicator.

According to an advantageous embodiment variant, the force transmission component comprises a locking portion designed to be inserted, while said component is moving in translation, into a peripheral recess of the contact of the electric termination and thus lock the latter in the body, preferably before or at the same time as the contact is clamped. As a result, the termination contact is blocked in a correct insertion position before the clamping force is applied to it.

According to an advantageous feature, the locking portion has a complementary shape to that of the peripheral recess of the contact of the electric termination.

According to an advantageous configuration, the second strip is mounted freely in the first strip at one of its ends, and free at the other of its ends.

With preference, the clamping cam is rotatably mounted between two arms of the first strip. This improves the reaction of the mechanical forces, in particular in environments that are restrictive in terms of temperature.

According to an advantageous variant, the force transmission component additionally comprises a return portion for returning the second strip to its rest position, during the unclamping operation after the contact is unlocked.

According to an advantageous embodiment, the body comprises an opening which is next to the cavity and is provided on the inside with at least one protuberance, or a plurality of longitudinal straight, preferably angularly regularly distributed, grooves each designed to respectively be received between two adjacent ribs of the sleeve of the electric cable termination, or receive a straight spline formed around the sleeve. The one or more protuberances or the splines of the sleeve of the termination make it possible to react twisting forces exerted by the cable on the body of the module. In addition, they make it possible to prevent the rotation of the contact by sliding, once it is clamped in the connection module.

By selecting small angular sectors between splines, an insertion of the contact in the module that does not need angular indexing is obtained.

According to an advantageous embodiment, the module comprises a locking/unlocking device for locking/unlocking the clamping mechanism, when the clamping cam is in its rotational position corresponding to the deformed position of the second strip.

According to a first embodiment variant, the locking device comprises:
a hole made in the interface component,
a rigid pin mounted on a spring, preferably a helical compression spring, the pin with the spring being accommodated inside the body of the module such that, in the deformed position of the second strip, the pin is inserted into the hole with the spring exerting a return force on the pin and thereby locks the clamping mechanism, it being unlocked by a torque applied to the interface component, which is designed to overcome the return force exerted by the spring.

According to a second embodiment variant, the locking device comprises:
a groove made in the interface component,
a rigid strip on a spring, preferably a helical compression spring, the rigid strip being partially accommodated and the spring being accommodated inside the body of the module such that, in the deformed position of the second strip, the free end of the strip is inserted in the groove with the spring exerting a return force on the strip and thereby locks the clamping mechanism, it being unlocked by pressing on that portion of the strip that protrudes from the body, which is designed to overcome the return force exerted by the spring.

According to a third embodiment variant, the locking device comprises:
at least one pin formed on the periphery of the interface component or of the clamping cam,
a spring, preferably a helical compression spring, accommodated inside the body of the module such that, in the deformed position of the second strip, the spring exerts a return force on the interface component and the clamping cam to trap the pin in the body by releasing the interface component from the body, and thereby locks the clamping mechanism, it being unlocked by pressing on the interface component, this pressing being designed to overcome the return force exerted by the spring.

According to a fourth embodiment variant, the locking device comprises:
a slot made on an outer face of the body, on the periphery of the interface component,
a flexible tab secured to or integrally formed with the interface component such that, in the deformed position of the second strip, the free end of the tab is inserted into the slot, and thereby locks the clamping mechanism, it being unlocked by releasing the free end of the tab, this releasing being designed to overcome the return force exerted by the flexible tab.

According to a fifth embodiment variant, the locking device comprises:
an interface component for a tool, this interface component being freely rotatably mounted in a receiving portion of the body and designed to be made to rotate by the tool, the interface component being a cylindrical component provided with a flattened portion, thereby forming a cam,
a locking component, of which one wall extends transversely to the longitudinal axis X and which is mounted movably in translation in the body between a clamping-mechanism locking position and an unlocking position, the locking component being arranged relative to the interface component such that, when the latter is:
   in its unlocking position, the cylindrical part of the cam mechanically interferes with another wall of the component, thereby preventing it from transitioning to its locking position,
   in its locking position, any rotation of the cam brings its flattened portion into abutment against a straight portion of said other wall of the locking component, thereby preventing it from transitioning to its unlocking position.

According to this fifth variant, when the component is in its locking position, the wall protrudes into an opening, and when the component is in its unlocking position, said wall is set back from the inside of the opening, the wall being designed to be inserted into a transverse recess of the sleeve of the electric termination and thus lock the latter in the body, preferably after or at the same time as the contact is clamped.

According to a first connection configuration, the first strip comprises a portion extending out of the body and designed to be electrically connected to a busbar by welding or screwing.

The electrical connection module may also be dedicated to a connection between harnesses, which is to say between at least two electric cable terminations, that are separate.

Thus, according to a second connection configuration, the module comprises:
two aligned or side-by-side bodies fixed to one another or forming a single one-piece component,
a single first strip being common to the cavities of the two bodies,
at least two second, mutually independent strips, each for clamping a contact,
at least two mutually independent clamping mechanisms. For instance, it is possible to connect at least two electric cable terminations in series within one and the same module.

According to this second embodiment and an alternative connection between one current input and three outputs, it is provided in the module that:
each body comprises at least two aligned or non-aligned cavities, the cavities extending preferably parallel to the longitudinal axis (X) of the module,
the two second strips of one and the same body are electrically interconnected, preferably common to the cavities of the two bodies, so as to produce an electric shunt between the at least four electric cable terminations when accommodated individually in the cavities.

According to a third connection configuration, the module comprises:
two aligned or side-by-side bodies fixed to one another or forming a single one-piece component,
a single first strip common to the cavities of the two bodies,
a single second strip comprising multiple independent, deformable parts, each for clamping a contact,
at least two mutually independent clamping mechanisms.

The invention also relates to a terminal block connection assembly comprising a plurality of modules of identical or different dimensions with cavities of identical or different dimensions for accommodating electric terminations of identical or different dimensions.

The invention lastly relates to a structure, in particular for an aircraft, comprising at least one electrical connection module as described above and/or at least one terminal block connection assembly as described above, preferably fixed on a rail support, which is itself intended to be fixed to the structure.

The invention has many advantages over the existing setup, including:
the elimination of problems of orienting the cables, which can be very rigid, by replacing the usual lugs with cylindrical contacts;
a reduction in the time needed to install the electric cables in a structure, in particular an aircraft structure, by way of a rapid mounting system which ensures effective clamping of the cable terminations, without requiring “torqueing”, which is to say by applying a specific clamping force with a view to obtaining maximum precision;
individual coupling of each electric termination in a single- or multi-cavity connection module;
effortless coupling since, before clamping, the distance between the two strips enables easy insertion without friction, this moreover having the advantage of not causing wear of the contact and/or of any coating it might have;
a high contact pressure between the electric contact of the cable termination and the contact strips within the module, thereby reducing the electrical contact resistance and thus enabling a high current transmission with reduced heating;
centering, over a considerable length, of the contact of the termination between the two contact strips within the module, which in conjunction with the high contact pressure makes it possible to obtain a resistance to vibrations and to wear of any coating the contact might have;
detection of the correct positioning of the termination contact in the module by virtue of the locking device for locking the clamping mechanism;
indication, both in visual terms (marking on the module in relation to an indicator on the interface component) and in sensory terms (mechanical stop of the termination contact), that the termination contact is clamped correctly in the module;
the elimination, in an aircraft structure, of existing umbrella components by virtue of the leaktight solution with connection modules that leaktightly accommodates the electric terminations in the cavities;
no risk of losing a component (FOD for “Foreign Object Damage”), since the solution according to the invention does not have independent, detachable components that need to be installed;
protection for the operators against electrical risks, because all they have to do now is directly manipulate the electrically insulating components (termination insulating sleeve and modules);
a high degree of modularity which can be easily adapted to various wiring configurations;
the connection module is particularly suitable for a high-voltage electric line (several hundred volts), since there is only a single potential in a connection module (phases and ground are separated in different modules) and the leakage and insulation paths between electrical conductors are longer.

The applications envisaged for a terminal block with modules according to the invention are numerous and include the wiring of civil aircraft.

Other advantages and features of the invention will become more clearly apparent upon reading the detailed description of exemplary embodiments of the invention, given by way of non-limiting illustration, and with reference to the following figures.

### BRIEF DESCRIPTION OF THE DRAWINGS

FIG. 1 shows a perspective view of an example of a screw terminal block according to the prior art used for electric wiring in the structures of an aircraft.

FIG. 2 is another perspective view of a screw terminal block according to the prior art showing cable harnesses with lugs connected in the terminal block.

FIG. 3 is a perspective view of a connection module according to a first embodiment of the invention, with two symmetrical bodies fixed to one another and having aligned cavities each accommodating a contact of an electric cable termination.

FIG. 4 is an exploded view of the module according to FIG. 3 with the two electric cable terminations.

FIG. 5 is a cross-sectional view through the body of a connection module according to the first embodiment of the invention, showing the clamping of the contact of a cable termination realized in the cavity of the body by means of the mechanism integrated in the latter.

FIGS. 6A and 6B are cross-sectional views through the clamping mechanism of a module, showing respectively the position before clamping and after clamping with locking of a contact of an electric cable termination.

FIGS. 7A, 7B and 7C are cutaway views, in partial perspective, at the clamping mechanism for clamping a module, showing respectively the position before clamping, a position of the contact of an electric cable termination making it impossible to clamp and lock, and after clamping with locking of the contact.

FIG. 8 reprises FIG. 7C from another point of view in perspective.

FIGS. 9A and 9B are cross-sectional views through the clamping mechanism of a module according to one embodiment variant, showing respectively the position after clamping with locking of a contact of an electric cable termination and the unclamped position after unlocking, the second strip being brought back to this position by a portion of the force transmission component.

FIG. 10 is a perspective view, in cross section, of a connection module according to a second embodiment of the invention, with a body of which the cavity accommodates a contact of an electric cable termination.

FIG. 11 is a perspective view of a module according to FIG. 10 shown after clamping with locking of a contact of an electric cable termination.

FIGS. 12A, 12B and 12C are perspective views of an insertion variant with prevention of the rotation of a contact of an electric cable termination in a module.

FIG. 13 is a view, in longitudinal section, of a variant with sealing of a connection module according to the invention with two bodies that are fixed to one another, each accommodating a contact of an electric cable termination.

FIG. 14 is a cross-sectional view of the module according to FIG. 13 showing the sealing at the clamping mechanism.

FIG. 15 is a perspective and cutaway view of a connection module according to the first embodiment with two bodies each accommodating two adjacent cavities, arranged side by side, showing the electric shunt realized within the module body by the deformable strip and the rigid strip.

FIG. 16 is a perspective view of an embodiment of a connection module according to the first embodiment with two bodies each accommodating two adjacent cavities, which makes it possible to establish an electrical connection between one input electric termination and three output electric terminations.

FIG. 17 is a cross-sectional view of a module according to FIG. 16, showing the electric shunt realized within one and the same module body by both the deformable strip and the rigid strip.

FIG. 18 is a perspective and cutaway view of a module according to FIG. 15, showing the electric shunt realized within one and the same module body but with just the rigid strip.

FIG. 19 is a perspective and cutaway view of a connection module according to the first embodiment with two bodies each accommodating two adjacent cavities, with mutually insulated rigid strips and likewise mutually insulated deformable strips.

FIG. 20 is a perspective and cutaway view of a connection module according to the first embodiment, according to a variant with a single one-piece second strip comprising two deformable parts.

FIG. 21 is a perspective view of one embodiment of a terminal block with multiple connection modules connected to one and the same busbar.

FIGS. 22A and 22B illustrate perspective views, in partial cutaway, of a first variant for locking/unlocking the clamping mechanism of a connection module according to the invention, respectively in the unlocked and the locked position of the latter.

FIGS. 23A and 23B illustrate perspective views, in partial cutaway, of a second variant for locking/unlocking the clamping mechanism of a connection module according to the invention, respectively in the unlocked and the locked position of the latter.

FIGS. 24A and 24B illustrate perspective views, in partial cutaway, of a third variant for locking/unlocking the clamping mechanism of a connection module according to the invention, respectively in the unlocked and the locked position of the latter.

FIGS. 25A and 25B illustrate perspective views, in partial cutaway, of a fourth variant for locking/unlocking the clamping mechanism of a connection module according to the invention, respectively in the unlocked and the locked position of the latter.

FIGS. 26 and 26A are views, respectively in perspective and in longitudinal section, of an electric termination and a connection module according to another embodiment of the invention with two bodies that are fixed to one another, each accommodating a contact of an electric cable termination, with a device for locking the contact of the termination and for securing this locking.

FIGS. 27A and 27B illustrate a view, in partial perspective, of a connection module according to the embodiment in FIGS. 26 and 26A, showing the holding in position of the locking component of the device to allow the insertion of a contact.

FIGS. 28A and 28B correspond respectively to FIGS. 27A and 27B, in a top view.

FIG. 29 illustrates a view, in partial perspective and in longitudinal section, of the position of the locking component in its unlocking position.

FIGS. 30A, 30B and 30C are perspective views, in longitudinal section, showing the various steps for inserting and locking a contact in a module according to the embodiments in FIGS. 26 and 26A.

FIGS. 31 and 32 are top views showing the securing of the locking of the contact at the end of the locking step according to FIG. 30C.

### DETAILED DESCRIPTION

Throughout the present application, the terms “vertical”, “lower”, “upper”, “bottom”, “top”, “below” and “above” are to be understood with respect to an electrical connection module in a configuration which is fixed, in particular to a rail support, in a horizontal arrangement.

Similarly, the terms “internal” and “external” are to be understood with respect to a body of an electrical connection module according to the invention.

For the sake of clarity, one and the same reference number has been used for elements that are one and the same of an electric cable according to the prior art and of an electric cable according to the invention.

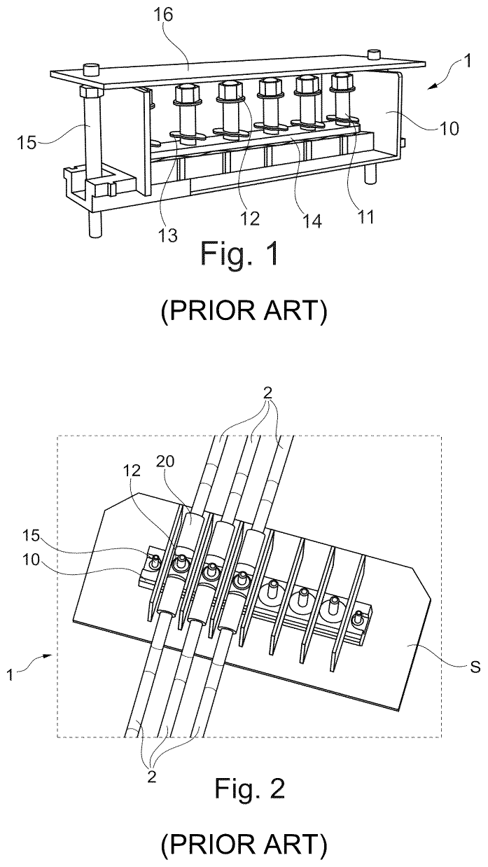

FIGS. 1 and 2 have already been described in detail in the preamble. They will therefore not be discussed below.

Elements that are one and the same are denoted by just one and the same reference number throughout FIGS. 1 to 32.

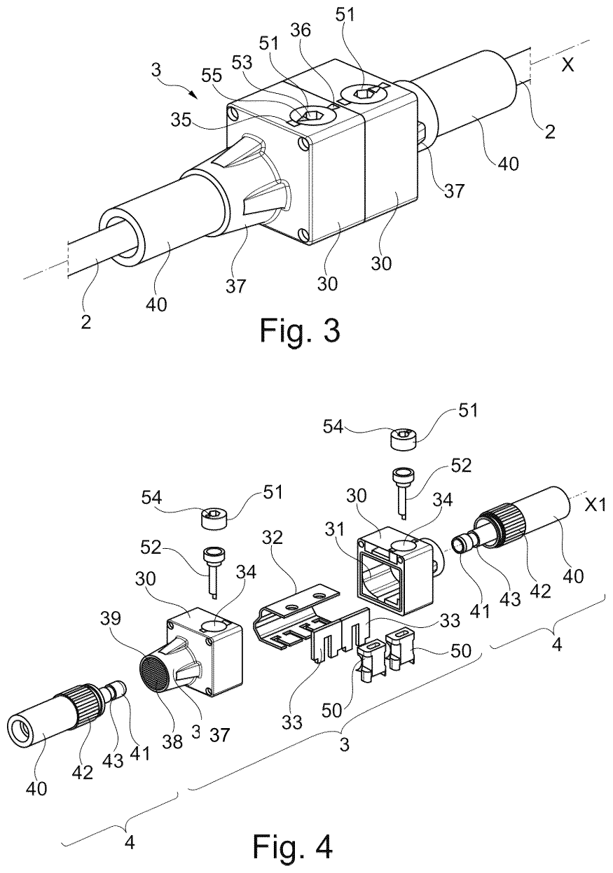

FIGS. 3 and 4 show an example of an electrical connection module according to a first embodiment of the invention, denoted overall by the reference 3 and intended to form part of a terminal block of a connection assembly.

This electrical connection module 3 comprises two bodies 30, which are preferably identical or symmetrical, fixed to one another. The means for fixing the two bodies 30 to one another are not shown but can be screws/nuts that pass all the way through the bodies.

Each body 30 is electrically insulating, of longitudinal axis X, and is intended to accommodate, clamp, lock and connect at least one termination 4 of an electric cable 2. This electric cable 2 comprises an outer sheath 20 surrounding an electrical conductor 21.

More specifically, each body 30 comprises a cavity 31 within it and the two cavities 31, which are preferably the same size, are next to one another and in each of them a termination 4 of an electric cable 2 is inserted, clamped and locked, as explained below.

An electric cable termination 4, of central axis X1, comprises an electrically insulating sleeve 40 and a cylindrical electric contact 41 crimped onto an electric cable 2, and inserted and fixed, in particular by snap fastening, inside the sleeve 40.

The sleeve 40 comprises, around its outer periphery, straight splines 42 which extend about the central axis X1 over some of the length of the sleeve.

The cylindrical contact 41 is provided with a peripheral recess 43 which makes it possible to detect the correct insertion of and to lock the contact 41 in the cavity 31 of a body 30, as explained later on.

A first, electrically conductive strip 32 is accommodated fixedly or with a very small amount of play to facilitate the mounting in each cavity 31 and the recentering of the contact of the termination after it is clamped against the strip. In the example illustrated in FIG. 4, this first strip 32, of U-shaped overall cross section, is common to the cavities 31 of the two bodies 30.

A second, preferably electrically conductive strip 33 is also accommodated in each cavity 31. This second strip 33 is elastically deformable between a rest position, in which it defines, together with the first strip 32, a space designed to allow the insertion of the contact 41 of the electric cable termination 4 along the axis X, and a deformed position, in which it clamps, together with the first strip, the contact of the electric cable termination transversely to the axis X, so as to establish electrical continuity between the contact 41 and the first and second strips 32 and 33.

To realize this deformation of the strip 33 and therefore the clamping of the contact 41, the module 3 integrates a clamping mechanism 5 in each body 30, which is accessible from the outside and can be actuated by a tool which makes it possible to supply a considerable clamping force.

This mechanism 5 comprises a force transmission component 50 accommodated in the body 30, an interface component 51 for a tool, this interface component being freely rotatably mounted in a receiving portion 34 of the body and designed to be made to rotate by the tool, and a clamping cam 52, secured to or integrally formed with the interface component 51.

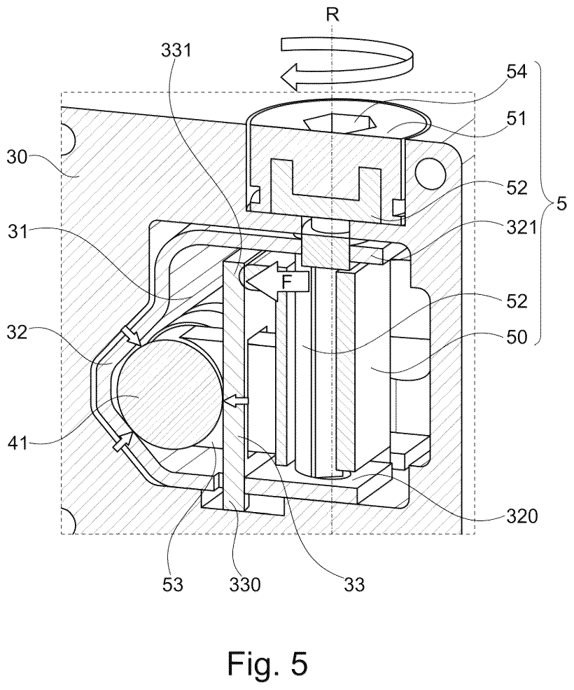

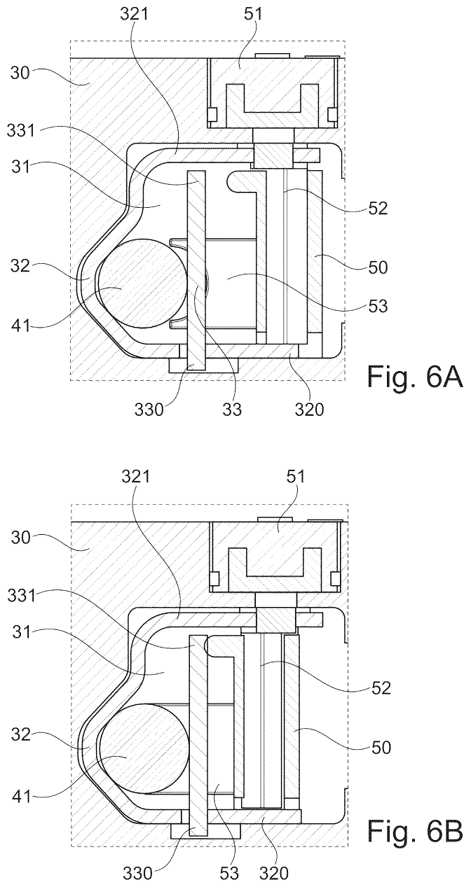

As FIG. 5 shows, when a contact 41 is inserted into the cavity 31, the rotation of the clamping cam 52 that is realized by way of the rotation (R) of the interface component 51 causes the transmission component 50 to move in translation, transversely to the axis X, which via the cam 52 exerts a force (F) on the second strip 33 to bring it from its rest position (FIG. 6A) into its deformed position of clamping the contact 41 (FIG. 6B).

As FIG. 5 also shows, the strips 32 and 33 are advantageously shaped to form three areas of direct linear contact that are arranged substantially at 120° relative to one another, as shown symbolically by the arrows, with the contact 41 in the deformed position of the second strip 33. The three angularly distributed areas of direct linear contact make it possible to balance the contact and mechanically stabilize it in the connection module.

According to an advantageous mounting, the second strip 33 is mounted freely in the first strip 32 at one of its ends 330, and free at the other of its ends 331 (FIGS. 5, 6A, 6B).

According to another advantageous mounting, the clamping cam 52 is rotatably mounted between two arms 320, 321 of the first strip 32 (FIGS. 5, 6A, 6B). This affords not just a compact mounting of the clamping mechanism 5 and of the strips 32, 33 but also an improvement in the reaction of mechanical forces being transmitted from the cam to the strip 32, in particular at a high temperature.

An advantageous variant consists in producing the force transmission component 50 with a locking portion 53 designed to be inserted, while the component 50 is moving in translation, into the peripheral recess 43 of the contact 41 of the electric termination 4 and thus lock the latter in the body, preferably before or at the same time as the contact is clamped. As FIG. 5 shows, this locking portion 53 preferably has a complementary shape to that of the peripheral recess 43 of the contact 41.

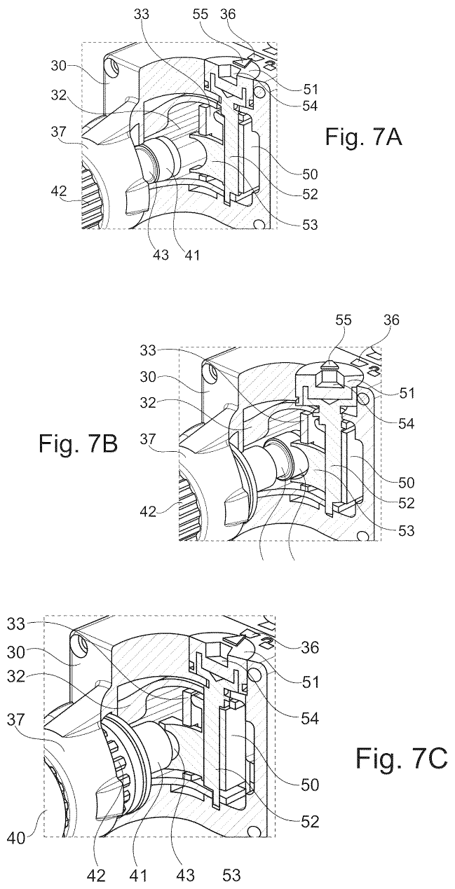

As a result, in the rest position of the strip 33 and when there is no rotation of the interface component 51, a contact 41 can be inserted freely, i.e. effortlessly, between the strips 32 and 33 (FIG. 7A). By contrast, if the interface component has undergone rotation and is no longer in its open position, the locking portion 53 mechanically interferes with the contact 41 when the latter is being inserted, preventing non-compliant mounting.

If the contact 41 is not inserted into the cavity 31 of the body 30 over a sufficient travel, the locking portion 53 of the component 50 abuts the cylindrical part of the contact 41 (FIG. 7B). As a result, in this configuration, it is impossible to lock the contact 41 in the cavity 31 and clamp it by way of the strip 33.

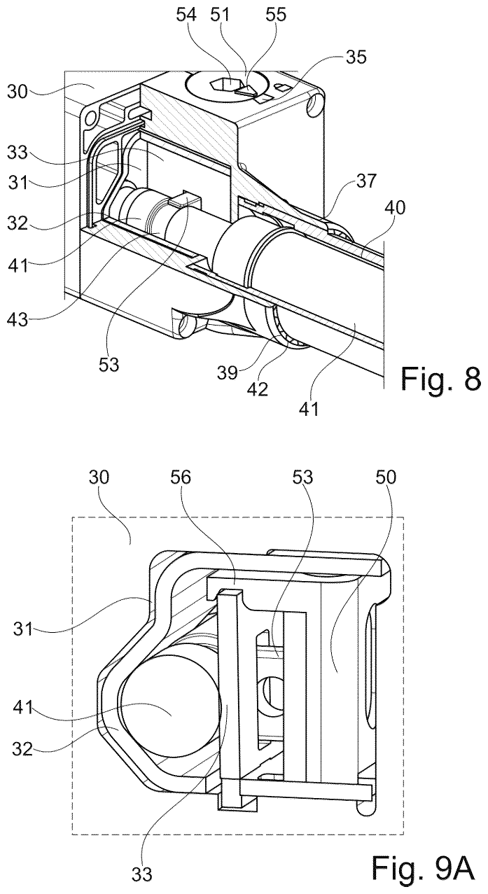

By contrast, if the contact 41 is correctly inserted into the cavity 31 of the body 30, the locking portion 53 of the component 50 is inserted into the peripheral recess 43 of the contact 41 and thus locks the latter in the cavity 31 (FIGS. 7C, 8). In other words, the contact is prevented from moving in translation along the axis X. The contact 41 can then be clamped between the fixed strip 32 and the strip 33 to be deformed.

The interface component 51 may comprise an interface recess 54 for the tool, preferably a hexagonal socket recess. An operator can thus use a conventional external tool, such as a hexagon key.

According to an advantageous embodiment variant, the body 30 of the module comprises at least one visual indicator 35, 36 and the interface component 51 also comprises at least one visual indicator 55. These visual indicators 35, 36, 55, in particular each in the form of a noticeable colored area, are arranged on the upper face of the body so as to be visible to an operator to indicate to them the correct clamping position of the contact 41 of the electric termination. For instance, in the example illustrated, an indicator 55 of the interface component 51, in the form of a colored arrow, is positioned next to an indicator 35 of the body, of a first color, for example green, when the clamping is effected and next to an indicator 36, of a second color, in a completely unclamped position of the contact, which corresponds to the rest position of the strip 33.

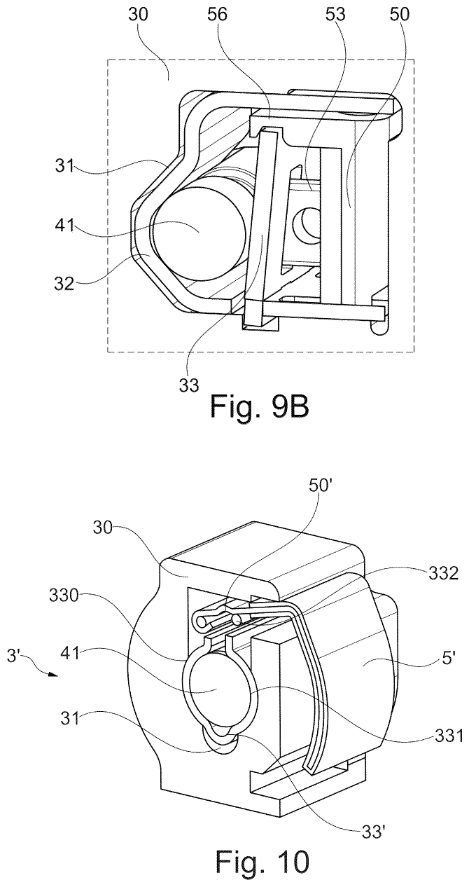

In an advantageous variant, the force transmission component 50 may also comprise a return portion 56 which is attached to the free end of the strip 33. In the example illustrated, this return portion 56 caps, as it were, this free end of the strip 33. As a result, when the contact 41 is being unlocked, this return portion 56 exerts a pulling force on the free end of the strip 33 and brings it from its deformed position (FIG. 9A) back to its rest position (FIG. 9B).

FIG. 10 shows an example of an electrical connection module according to a second embodiment of the invention, denoted overall by the reference 3′ and also intended to form part of a terminal block of a connection assembly.

This electrical connection module 3′ comprises an electrically insulating body 30 intended to accommodate, clamp, lock and connect a termination 4 of an electric cable 2, as has already been described.

In this instance, the module 3′ comprises a single strip 33′ of substantially U-shaped cross section, which is accommodated in the cavity 31 of the module. One of the arms 330 of the U is rigid and fixed; the other one of the arms 331 can be deformed so as to move closer to the fixed arm 330.

The clamping mechanism 5′ in this case consists of a single lever mounted pivotably about the fixed arm 330 while being accessible from the outside of the body 30.

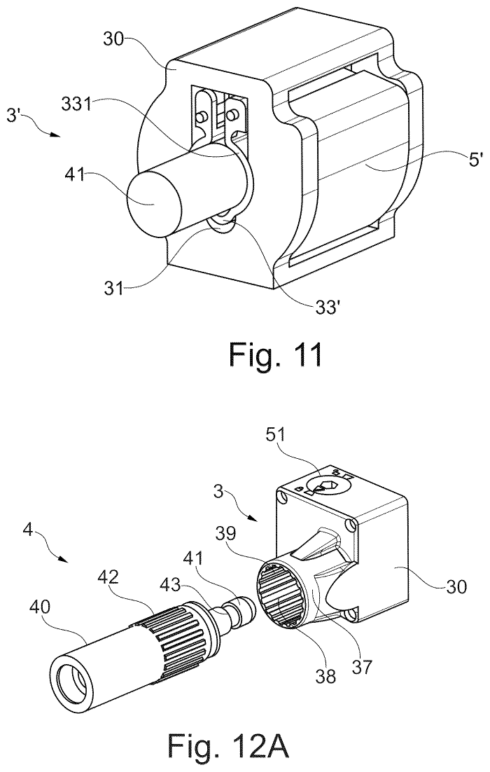

Thus, once the contact 41 has been inserted freely-effortlessly-between the two arms 330, 331 at a spacing from one another and in the rest position (FIG. 10), pivoting the lever 5′ downward in the example illustrated makes it possible to accommodate, with blockage, the free end 332 of the arm 331 in a suitable receiving portion 50′ of the lever, thereby causing the arm 331 to move closer to the arm 330 by deforming (FIG. 11). As a result, in the deformed position of the arm 331, the contact 41 is clamped by the two arms 330, 331, which define two mutually facing areas of direct surface contact with the contact 41. These two angularly distributed areas of direct surface contact make it possible to balance the contact and mechanically stabilize it in the connection module. As shown in FIG. 11, the shape and the dimensions of the lever 5′ are advantageously selected to follow the outside of the body 30 of the module as closely as possible, without projecting outward.

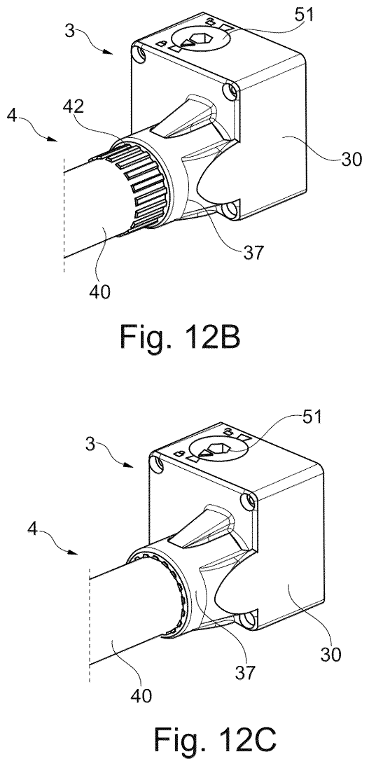

As FIGS. 12A to 12C show in detail, it is possible to produce part of the module body 30 and an electric cable termination 4 so as to prevent the latter from rotating once its contact is inserted in a cavity 31.

Thus, as shown, the body 30 comprises a tubular continuation with an opening 38 next to the cavity 31, which is provided on the inside with a plurality of longitudinal straight, preferably angularly regularly distributed, grooves 39 each designed to receive a straight spline 42 formed around the sleeve 40 of the electric cable termination 4.

The splines 42 allow reaction of the twisting forces exerted by the cable 2 on the body of the module 3 and also prevent the rotation of the contact 41 by sliding, once the latter is inserted and clamped in the connection module 3.

The splines 42 are preferably at a small angular spacing from one another, thereby allowing the contact 41 to be inserted into the body 30 of the module without having to rotationally index it beforehand.

It is possible to envisage a leaktight alternative connection between the one or more contacts 41 of the termination 4 and the one or more bodies 30 of the module.

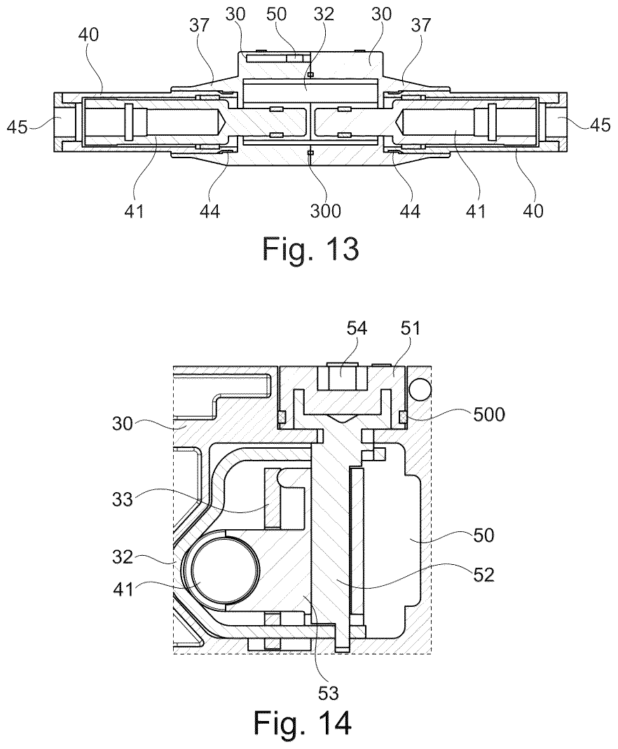

As FIG. 13 shows, this variant may for example consist in installing at least one O ring 44 on the free end of the sleeve 40, at the interface with the body 30, and at least one annular grommet 45 mounted in the other end of the sleeve 40 at the interface with the cable 2.

It is also possible to provide an O ring 300 at the interface between two bodies 30 fixed to one another.

In addition, it is possible to provide an O ring 500 arranged around the interface component 51, in its receiving portion (FIG. 14).

The connection modules according to the invention enable various configurations for a connection between electric harnesses with electric cable terminations 4.

As described and illustrated above, one and the same module 3 may comprise two preferably identical or symmetrical bodies 30 aligned next to and fixed to one another. This enables an electrical connection with a single input and output.

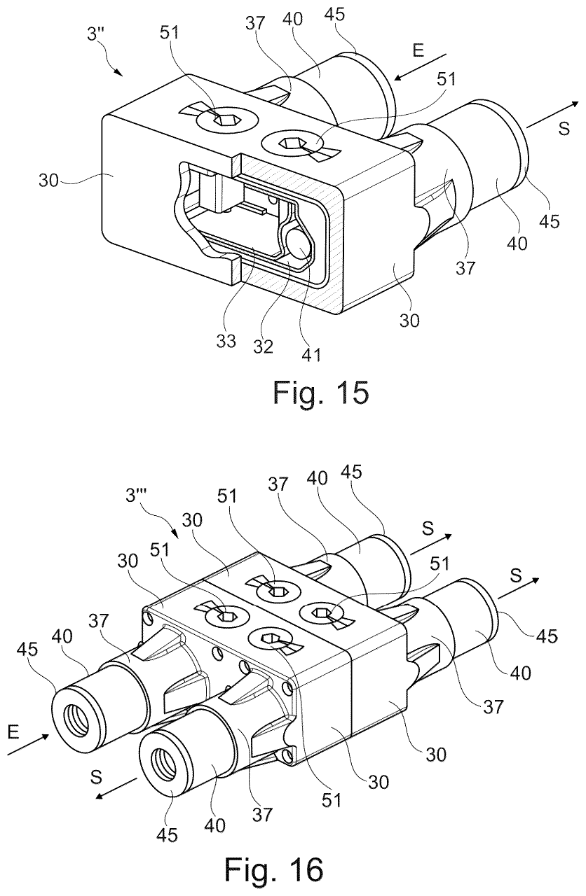

It is also possible to envisage a connection module 3″ with two bodies 30 arranged next to one another, electrically connecting two cable terminations arriving on one and the same side of the module (FIG. 15). As can be seen in this FIG. 15, a single first strip 32 and a second strip 33 are accommodated in the cavities 31. The single strip 33 comprises two parts that are deformable independently of one another with a cam clamping mechanism 51 and are electrically interconnected, so as to form an electric shunt between the two electric cable terminations 4 when they are inserted individually in the cavities. The two bodies 30 may be fixed to one another or integrally formed as a single one-piece component.

This variant with side-by-side module bodies can for example be implemented on one and the same face of a panel.

Other configurations with multiple outputs are possible.

FIGS. 16 to 18 illustrate a variant with one electrical input E and three electrical outputs S with an electric shunt formed inside the bodies 30 of a connection module 3″ according to the first embodiment.

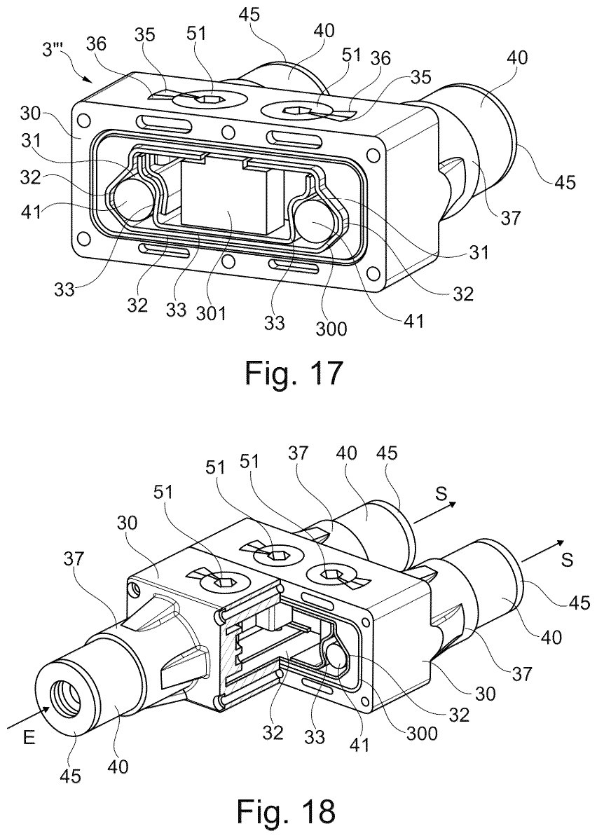

More specifically, as FIGS. 17 and 18 show, the module 3″ comprises two aligned bodies 30 fixed to one another, each of the bodies 30 on the inside comprising two cavities 31 extending parallel to the longitudinal axis (X) of the module.

Each contact 41 is clamped by means of a clamping mechanism 5 independent of the others.

The first strip 32 is common to the cavities 31 of the two bodies 30.

In the variant in FIG. 17, two mutually independent second strips 33 are accommodated in the cavities 31 and are electrically interconnected, so as to form an electric shunt between the four electric cable terminations 4 when they are inserted individually in the cavities.

To keep the strips 32, 33 inside the body 30, it is possible to provide a retaining spacer 301.

An alternative for forming the electric shunt is shown in FIG. 18: the shunt is formed solely by the first strip 32, the deformable strips 33 being electrically insulated from one another.

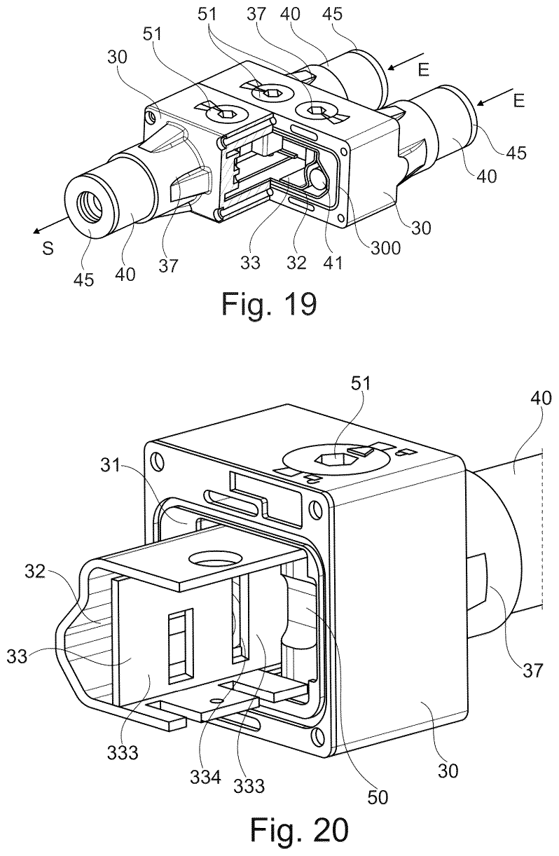

Another variant with two inputs E and two outputs S, illustrated in FIG. 19, can consist of two aligned and fixed bodies 30 each comprising two cavities 31, but does not involve shunting of the two electric lines. In other words, the two electric lines pass through the connection module electrically independently of one another. In this variant, the module comprises two first fixed strips 32 which are independent of and electrically insulated from one another, and at least one second deformable strip 33 per electric line, these second deformable strips being insulated between each electric line.

An alternative embodiment for the second strip 33 is shown in FIG. 20: it is possible to provide for the production of a single strip 33 in the form of a one-piece component which can be accommodated in two cavities 31 next to one another, with parts 333 that are elastically deformable independently of one another, for example by creating one or more perforations 334 in the material between them.

Another possible configuration with connection modules according to the invention is a connection of multiple terminations 4 of electric cables 2 to a busbar or connection bar.

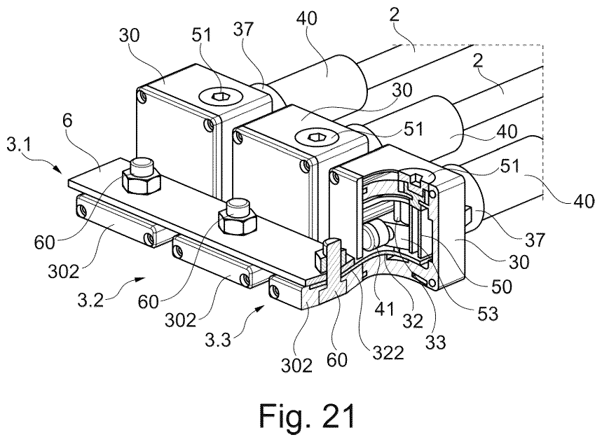

Such a configuration is illustrated in FIG. 21 with three preferably identical modules 3.1, 3.2, 3.3 arranged next to one another in parallel. In this configuration illustrated, each body 30 of the modules comprises a single cavity 31 in which is inserted and clamped a contact 41 of a termination 4 of an electric cable 2.

Each of the first strips 32 comprises an extension portion 322 extending out of the body 30.

Each body 30 comprises a continuation 302 which has the shape of a right parallelepiped and supports a portion 322 of a strip 32.

The parallel electrical connection between the various strips 32 and thus between the electric terminations 4 is effected by a common busbar 6 which is fixed by means of a screw/nut 60 in the extension portion 322 of each strip 32. It is possible, of course, to envisage, instead of the screws/nuts 60, fixation to the busbar by welding.

To ensure the contact 41 in a module body 30 is prevented from becoming unlocked, which could be brought about for example in the event of vibrations, impacts, or the like, a module 3 can be provided with a locking/unlocking device 7 for locking/unlocking the clamping mechanism 5.

This device 7 is configured to be active when the clamping cam 52 is in its rotational position corresponding to the deformed position of the second strip 33.

Several advantageous design variants can be envisaged.

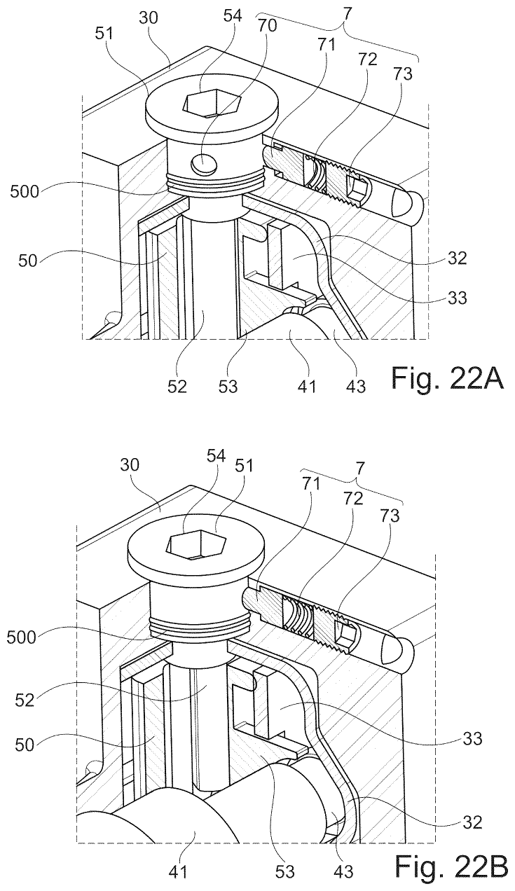

FIGS. 22A and 22B show a first variant of such a device 7 which comprises:
a hole 70 made in the interface component 51,
a rigid pin 71 mounted on a spring 72, preferably a helical compression spring. A set screw 73 makes it possible to hold the spring in the body and adjust its tension.

This pin 71 with the spring 72 are accommodated inside the body 30 such that, in the deformed position of the second strip 33, the pin 71 is inserted in the hole 70 with the spring exerting a return force on the pin (FIG. 22B). This locks the clamping mechanism 5. It is unlocked by a torque applied to the interface component 51, which is designed to overcome the return force exerted by the spring 72 and thus bring the pin 71 out of the hole 70 (FIG. 22A).

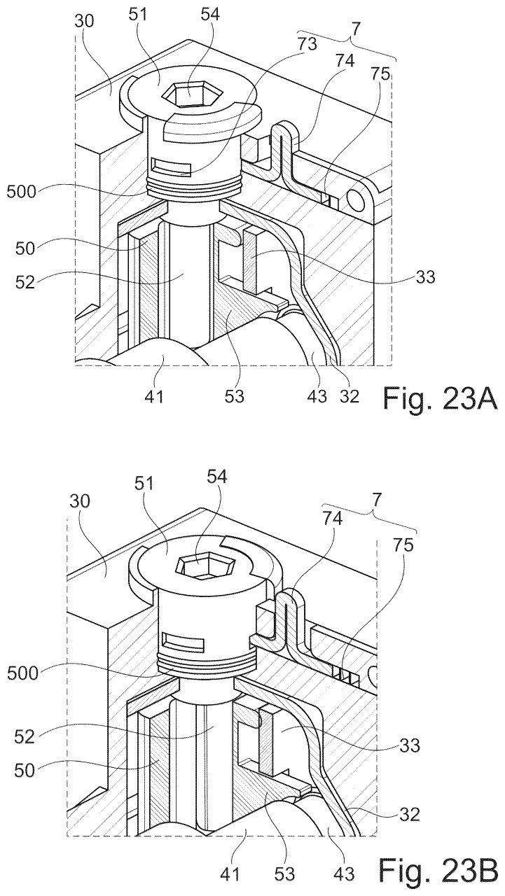

FIGS. 23A and 23B show a second variant of a device 7 which comprises:
a groove 73 made in the interface component 51,
a rigid strip 74 on a spring 75, preferably a helical compression spring.

The rigid strip 74 is partially accommodated and the spring 75 is accommodated inside the body 30 such that, in the deformed position of the second strip 33, the free end of the strip 74 is inserted in the groove 73 with the spring exerting a return force on the strip (FIG. 23B). This locks the clamping mechanism 5. It is unlocked by pressing on a portion of the strip 74 that protrudes from the body, which is designed to overcome the return force exerted by the spring 75 and thus bring the strip 74 out of the groove 73 (FIG. 23A).

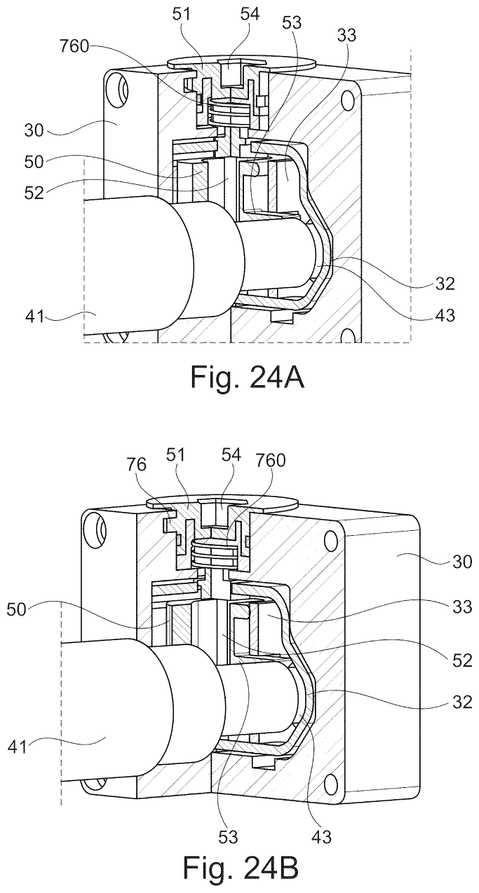

FIGS. 24A and 24B show a third variant of a device 7 which comprises:
at least one pin 76 formed on the periphery of the interface component 51,
a spring 760, preferably a helical compression spring, accommodated inside the cam 52.

In the deformed position of the second strip 33, the spring 760 pushes the interface component 51, the pin 76 of which is accommodated in a vertical groove formed in the body, back up and out of the body 30. When the pin 76 is accommodated in the vertical groove of the body, the interface component 51 and the cam 52 are prevented from rotating.

To unclamp the contact, an operator presses vertically downward with a tool, in the recess 54 of the interface component 51. The latter is driven into the body and thus compresses the spring 760. At the same time, the pin 76 of the interface component comes out of its receiving portion and is accommodated in a horizontal circular groove formed in the body. The rotational movement of the interface component 51 then becomes possible, causing the cam 52 to rotate and therefore the second strip 33 to return to the rest position and thus the contact to unclamp.

This unlocks the clamping mechanism 5 (FIG. 24A).

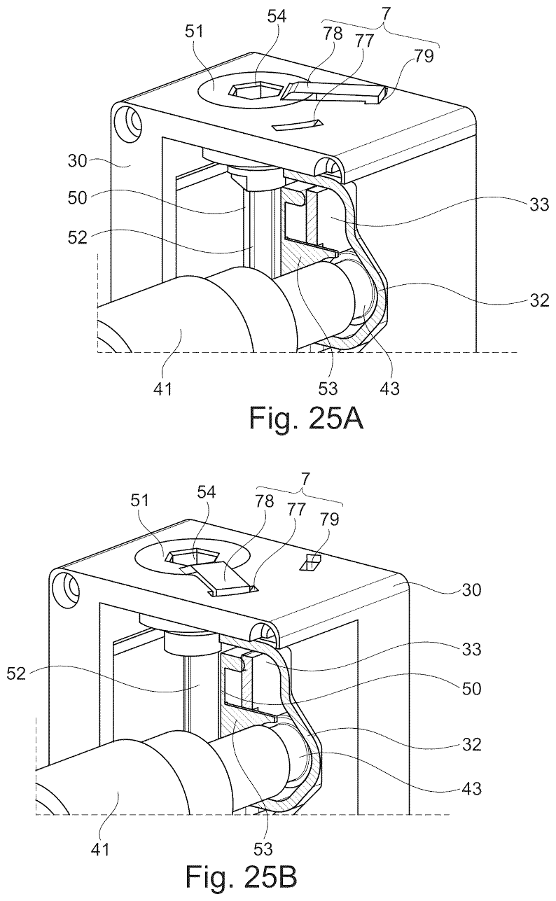

FIGS. 25A and 25B show a fourth variant of a device 7 which comprises:
a slot 77 made on an outer face of the body, on the periphery of the interface component,
a flexible tab 78 secured to or integrally formed with the interface component such that, in the deformed position of the second strip 33, the free end of the tab 78 is inserted into the slot 77 (FIG. 25B). This locks the clamping mechanism 5. It is unlocked by releasing the free end of the tab 78, this releasing being designed to overcome the return force exerted by the flexible tab (FIG. 25A). It is possible to provide another slot 79 for accommodating this free end in the unclamped position of the contact 41 corresponding to the rest position of the strip 33.

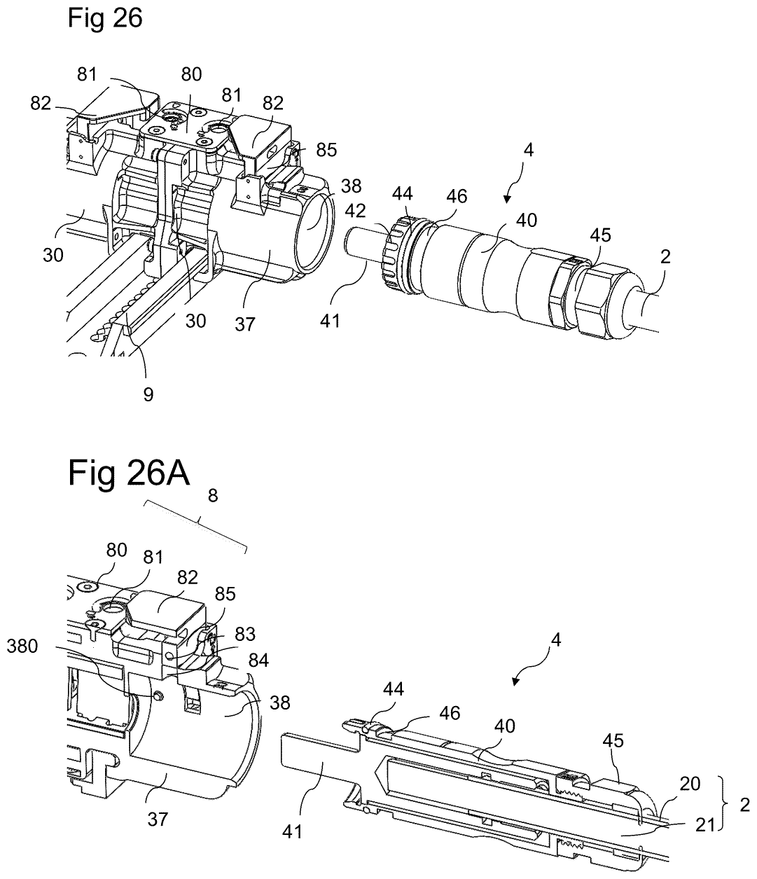

FIGS. 26 and 26A show a connection module according to another embodiment of the invention with two bodies 30 fixed to one another, each intended to accommodate a contact 41 of an electric cable termination 4.

According to this other embodiment, a locking/unlocking device 8 for locking/unlocking the clamping mechanism 5 once the contact 41 is in a position inserted in a cavity 31 of a body 30 is provided. The device 8 also makes it possible to detect the insertion of a termination in the casing to the correct longitudinal position.

As illustrated, the bodies 30 are furthermore fixed to a rail support 9, which is itself fixed to a structure, such as an aircraft structure.

In this embodiment, the sleeve 41 comprises a peripheral recess 46.

The device 8 for locking and securing this locking firstly comprises a bracket 80 preferably fixed on the body 30 by screwing.

An interface component 81 is freely rotatably mounted in a receiving portion of the body 30. This component 81 is a cylindrical component provided with a flattened portion and thus forms a cam. This cam 81 can be made to rotate by a tool, by way of the presence of a recess, which can be conventional. The interface component 81 is held in the receiving portion of the body 30 by the bracket 80.

A locking component 82, 83 is mounted movably in translation in the body 30 between a locking position, in which one wall 83 of the component that extends transversely to the longitudinal axis X protrudes into the opening 38, and an unlocking position, in which said wall 83 is set back from the inside of the opening 38. In this unlocking position, a contact 40 can therefore be inserted freely into the body 30 so as to be accommodated in the cavity 31, since the sleeve 40 can slide freely inside the opening 38 without interfering with the locking component 82, 83, which is set back from the inside of the opening 38.

The locking wall 83 can move in translation from its unlocking position to its locking position in a groove 84 provided for this in the body 30 by bearing against another wall 82 of the locking component, in the continuation of the wall 83.

The wall 83 additionally comprises at least one visual indicator 85. This visual indicator 85, in particular in the form of a noticeable colored area, is arranged on the outer face of the wall 83 so as to be visible to an operator to indicate to them the locking or unlocking position of the sleeve 40 and thus of the contact 41 of the electric termination 4. For instance, in the example illustrated, the indicator 85 of the wall 83, in the form of a colored area, is positioned on the outside of the body 30 when the wall 83 is set back from the opening 38 and thus in the unlocking position, and is no longer visible from the outside in the position protruding into the opening 38 and thus in the locking position of the sleeve 40 by the wall 83.

Furthermore, the bracket 80 may comprise one or more visual indicators, in particular in the form of engravings or markings of padlocks for visually indicating the rotational position of the cam 81, as explained below.

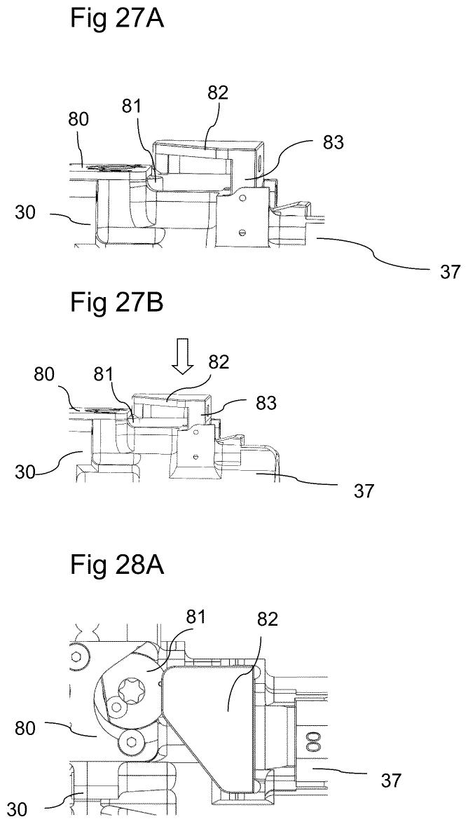

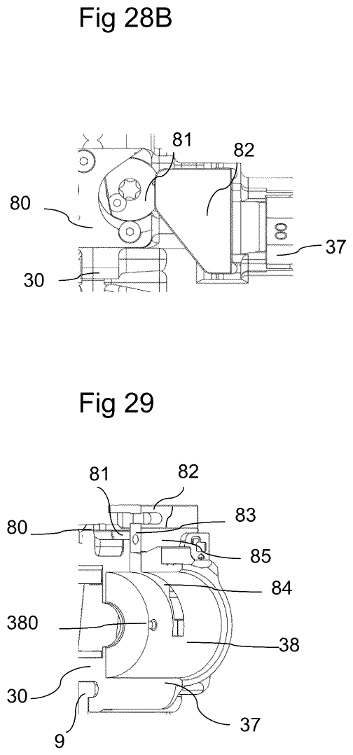

A description will now be given, with reference to FIGS. 27A to 28B, of the operation of the device 8 for locking the rotation of the clamping mechanism 5, while still ensuring the detection of the insertion to the correct longitudinal position in the body 30 of the termination 4.

The cam 81 is in a position in which it blocks the wall 82 of the locking component. The position in which the wall 82 is blocked by the cam 81 in itself indicates that the clamping mechanism 5 is in a partially or completely open/unclamped position. This blocking position can be visually indicated to an operator by a visual indicator on the bracket. It may be an indicator showing an open padlock. In this blocking position, the component 82, 83 is therefore in its unlocking position, i.e. the wall 83 is set back from the inside of the opening 38.

As shown symbolically by the arrow in FIG. 27B, pressing on the wall 82 advertently or inadvertently brings the latter into mechanical interference with the cam 81.

As a result, as shown in FIG. 29, in this position in which the component 82, 83 is blocked and which corresponds to its unlocking position, the wall 83 does not protrude into the opening 38 and therefore a contact 41 can be inserted therein so as to be accommodated in the cavity 31 of the body 30. In other words, the wall 83 does not obstruct the passage diameter of the sleeve 40.

The insertion and the locking of the contact 41 are as follows.

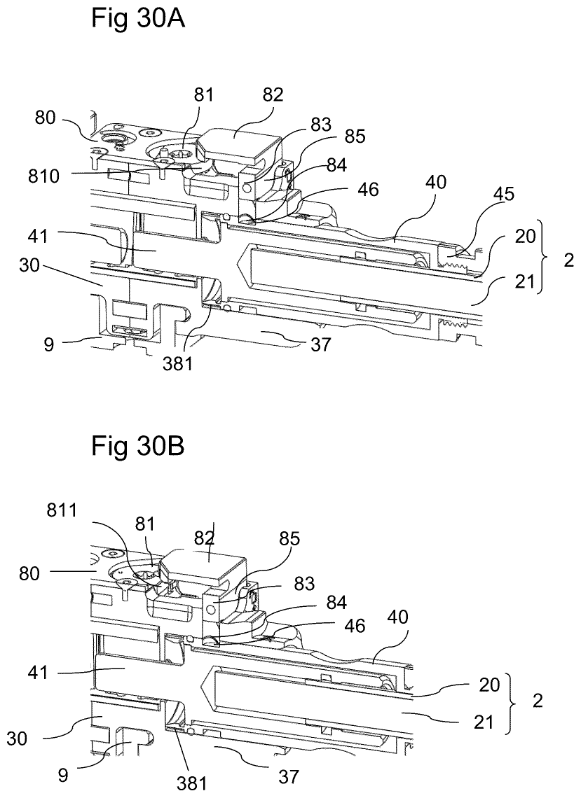

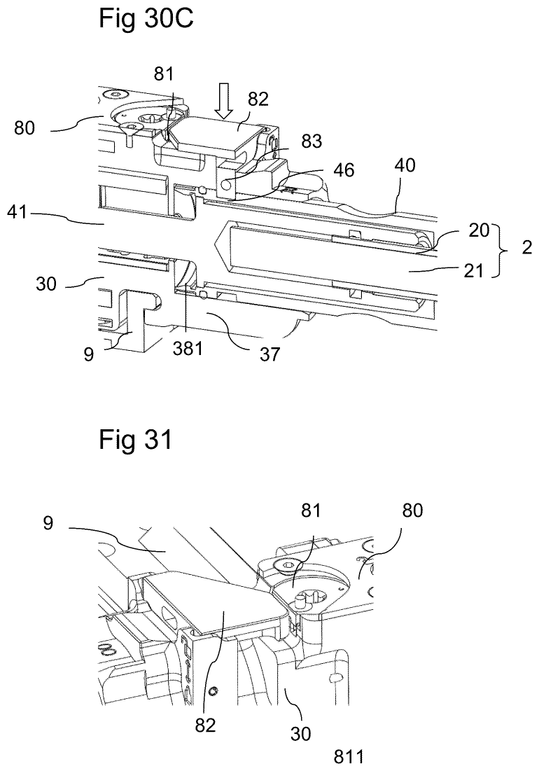

The contact 41 is inserted by an operator into the opening 38 and into the cavity 31 with the cam 81 and the component 82, 83 in the position in FIG. 29, until the groove 46 of the sleeve and the groove 84 are aligned along the axis X, or in other words next to one another (FIG. 30A). To ensure the correct alignment, it is possible to provide the front end of the sleeve 40 with a skirt 381 that axially abuts a surface at the bottom of the opening 38. In this position, the cylindrical part 810 of the cam 81 prevents any inward movement in translation of the component 82, 83.

Once this correct alignment has been reached, the operator can rotate the cam 81 as far as a stop position, which can be indicated by a visual indicator on the bracket 80, for example by a closed padlock (FIG. 30B). The rotation of the interface component 81 causes the displacement of the clamping mechanism 5, bringing the strip 33 into its deformed position of clamping the contact 41, via the movement in translation of the force transmission component 50. In this position of the cam 81, its flattened portion 811 is next to a straight part of the wall 82.

The contact 41, for its part, is clamped by the one or more strips 32, 33 in at least two areas of direct linear or surface contact.

The operator then presses on the wall 82, as shown symbolically by the arrow in FIG. 30C, and this brings the wall 83 into the locking position, in which it is inserted in the groove 46 of the sleeve 40 (FIG. 30C). The visual indicator 85 is then no longer noticeable from the outside, indicating to the operator the correct locking positioning of the component 82, 83. The locking of the component 82, 83 also indicates to the operator that the sleeve 40 has been inserted to its correct longitudinal position in the opening 38 beforehand. In other words, the locking of the component 82, 83 makes it possible to detect the insertion of the termination 4 to its correct longitudinal position in the module, after the contact 41 has been clamped by the strips 32, 33.

The locking of the clamping mechanism 5 is additionally secured since the flattened portion 811 of the cam is next to a straight portion of the wall 82 (FIG. 31).

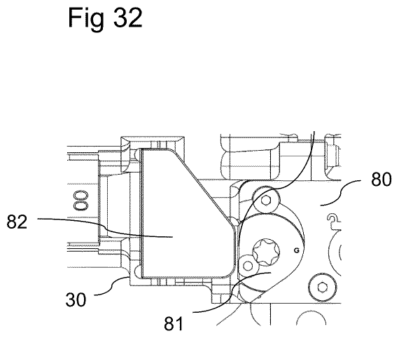

As a result, in this configuration, if the operator rotates the cam 81, its flattened portion 811 immediately comes into abutment with the wall 82, which is in its locking position (FIG. 32). In other words, the cam 81 cannot put itself into an unlocking position that would make it possible to release the constraints exerted on the contact 41 by the strips 32, 33.

In the configuration of a module in which the clamping mechanism 5 is activated and in which the component 82, 83 is locked, prior to inserting a termination 4 into the module, the operator could not insert the termination into the module, owing to the interference between the sleeve 40 and the wall 83. To make it possible to insert a termination into the module, the operator then, before they can do so, needs to bring the component 82, 83 into its unlocking position, and then bring the cam 81 into the unlocking position.

Other variants and improvements may be provided without thereby departing from the scope of the invention.

It is possible to provide modules of different dimensions with a different number of cavities for accommodating electric cable terminations 4 of different sizes.

It is also possible to provide fixing and locking of a connection module in a rail support 9, as shown in the embodiment in FIGS. 26 to 32.

As is evident from the description, to clamp an electric termination contact it is possible to provide a connection module with a single strip of which at least one part is elastically deformable, or with a rigid strip and a deformable strip.

Although in the examples illustrated, the cam clamping mechanism is described in relation to the first embodiment with a rigid strip and an elastically deformable strip, whereas the pivoting-lever clamping mechanism is described in relation to a single strip of U-shaped cross section, it is also possible to envisage a pivoting lever for the deformation of the strip clamping the contact with a rigid strip and a clamping cam for moving the arms of the single U-shaped strip closer to one another.

In the examples illustrated, the deformable strip 33 is electrically conductive. It is also possible to envisage an electrically insulating strip.

As FIGS. 26A and 29 show, instead of straight grooves 39 it is possible to provide one or more protuberances 380, for example produced by molding, protruding into the body 30, in particular into the opening 38, for making it possible to prevent the rotation of the sleeve 40 and therefore of the contact 41 by sliding, once it is clamped in the connection module. A protuberance 380 may take the form of a molded inner longitudinal rib/spline that can be interposed between the ribs 42 of the sleeve. A protuberance 380 may also take the form of a cylindrical metal pin inserted through the wall 37 of the body 30, perpendicularly to the axis X.

The expression “having a” is to be understood as a synonym for “having at least one”, unless specified to the contrary.

1. An electrical connection module intended to form part of a terminal block of a connection assembly, of longitudinal axis (X), comprising:
at least one body made of electrically insulating material comprising at least one cavity extending along the axis X and designed to accommodate an electric cable termination, comprising a contact intended to be attached to an electric cable;
at least one strip, comprising at least one part of a strip which is electrically conductive and accommodated, fixedly or with play, at least partially in the cavity, and at least one part of a strip which is elastically deformable between a rest position, in which it defines a space designed to enable the insertion of the contact of the electric cable termination along the axis X, and a deformed position in which it clamps the contact of the electric cable termination transversely to the axis X so as to establish electrical continuity between the contact and the one or more strips;
at least one clamping mechanism intended to be actuated by rotation from the outside, comprising a means for converting a rotational movement into a translational movement transversely to the axis X, which exerts a force (F) on the deformable part of the strip to bring it from its rest position to its deformed position of clamping the contact of the electric cable termination,
the one or more strips being shaped so as to form at least two areas of direct linear or surface contact with the contact of the electric termination in the deformed position, the at least two contact areas being angularly distributed around the periphery of the contact.

2. The electrical connection module as claimed in claim 1, comprising a single strip with a substantially U-shaped cross section transversely to the axis X.

3. The electrical connection module as claimed in claim 2, the clamping mechanism comprising a lever mounted pivotably in the body and accessible from the outside so as to deform at least one of the two arms of the U and thus bring it from its rest position to its deformed position.

4. The electrical connection module as claimed in claim 1, comprising at least one electrically conductive, rigid first strip accommodated in the cavity, and at least one electrically conductive second strip accommodated in the cavity and comprising at least one part which is elastically deformable between the rest position and the deformed position.

5. The electrical connection module as claimed in claim 4, the clamping mechanism comprising:
a force transmission component accommodated in the body,
an interface component for a tool, this interface component being freely rotatably mounted in a receiving portion of the body and designed to be made to rotate by the tool,
a clamping cam secured to or integrally formed with the interface component, the rotation of the clamping cam causing the force transmission component to move in translation transversely to the axis X, which exerts a force (F) on the second strip to bring it from its rest position to its deformed position of clamping the contact of the electric cable termination.

6. The electrical connection module as claimed in claim 4, wherein the force transmission component comprises a locking portion designed to be inserted, while said component is moving in translation, into a peripheral recess of the contact of the electric termination and thus lock the latter in the body.

7. The electrical connection module as claimed in one of claim 4, the clamping cam being rotatably mounted between two arms of the first strip.

8. The electrical connection module as claimed in one of claim 5, the force transmission component additionally comprising a return portion for returning the second strip to its rest position, during the unclamping operation after the contact is unlocked.

9. The electrical connection module as claimed in claim 4, comprising a locking/unlocking device for locking/unlocking the clamping mechanism, when the clamping cam is in its rotational position corresponding to the deformed position of the second strip.

10. The electrical connection module as claimed in claim 9, wherein the locking/unlocking device comprises:
an interface component for a tool (H), this interface component being freely rotatably mounted in a receiving portion of the body and designed to be made to rotate by the tool, the interface component being a cylindrical component provided with a flattened portion, thereby forming a cam,
a locking component, of which one wall extends transversely to the longitudinal axis X and which is mounted movably in translation in the body between a clamping-mechanism locking position and an unlocking position, the locking component being arranged relative to the interface component such that, when said interface component is:
in its unlocking position, the cylindrical part of the cam mechanically interferes with another wall of the component, thereby preventing it from transitioning to its locking position,
in its locking position, any rotation of the cam brings its flattened portion into abutment against a straight portion of said other wall of the locking component, thereby preventing it from transitioning to its unlocking position.

11. The module as claimed in claim 10, in which, when the component is in its locking position, the wall protrudes into an opening, and when the component is in its unlocking position, said wall is set back from the inside of the opening, the wall being designed to be inserted into a transverse recess of the sleeve of the electric termination and thus lock the latter in the body.

12. The electrical connection module as claimed in claim 1, wherein the body comprises an opening which is next to the cavity and is provided on the inside with at least one protuberance, or a plurality of longitudinal straight, grooves each designed to respectively be received between two adjacent ribs of the sleeve of the electric cable termination, or receive a straight spline formed around the sleeve.

13. The electrical connection module as claimed in claim 1, wherein the strip comprises a portion extending out of the body and designed to be electrically connected to a busbar by welding or screwing.

14. The electrical connection module as claimed in claim 4, comprising:
two aligned or side-by-side bodies fixed to one another or forming a single one-piece component,
a single first strip common to the cavities of the two bodies,
at least two second, mutually independent strips, each for clamping a contact,
at least two mutually independent clamping mechanisms.

15. The electrical connection module as claimed in claim 4, comprising:
two aligned or side-by-side bodies fixed to one another or forming a single one-piece component,
a single first strip common to the cavities of the two bodies,
a single second strip comprising multiple independent, deformable parts, each for clamping a contact,
at least two mutually independent clamping mechanisms.

16. A terminal block connection assembly comprising a plurality of electrical connection modules as claimed in claim 1, of identical or different dimensions with cavities of identical or different dimensions for accommodating electric terminations of identical or different dimensions.

17. A structure, in particular for an aircraft, comprising at least one electrical connection module as claimed in claim 1 and/or at least one terminal block connection assembly as claimed in claim 16, preferably fixed on a rail support, which is itself intended to be fixed to the structure.
